(19) United States
(12) Patent Application Publication
(10) Pub. No.: US 2016/0303715 A1
(43) Pub. Date: Oct. 20, 2016

(54) WRENCH STRUCTURE HAVING SWINGABLE RATCHET

(71) Applicant: Ping Chung HUANG, Taichung (TW)

(72) Inventor: Ping Chung HUANG, Taichung (TW)

(21) Appl. No.: 14/690,778

(22) Filed: Apr. 20, 2015

(51) Int. Cl. B25B 13/46

(52) U.S. Cl. CPC B25B 13/463

(57) ABSTRACT

The present disclosure illustrates an improved structure of a wrench having a swingable ratchet. In this improved structure, a head portion of a main body includes a through hole to contain a driving member, a cover of a block ring is used to restrict the driving member to stay within the through hole, and a connector of the driving member is abutted against an inner rim of the via hole of the cover by a periphery thereof, so as to restrict a bias swing angle of the driving member in a width direction of the head portion, and block teeth of the detent member can be fully engaged with the ratchet without being departed from the ratchet.

### BACKGROUND OF THE INVENTION

1. Field of the Invention

The present disclosure relates to a rachet wrench, more particularly to an improved structure of wrench having swingable ratchet.

2. Description of the Related Art

Please refer to FIG. 9 which shows a traditional rachet wrench. In a main body 91, a driving member 94 is contained in a through hole 93 of a head portion 92, and a cover piece 95 is used to restrict the driving member 94 within the through hole 93. In detail, the driving member 94 further includes a spherical-shaped ratchet 941 and a connector 942. The connector 942 is protruded from a via hole 951 of the cover piece 95 and bias swung along with rotation of the spherical-shaped ratchet 941 in a through hole 93. In the head portion 92, block teeth 961 of the detent member 96 is configured to block the ratchet 941, so that the ratchet 941 is limited to unidirectionally rotate only.

The traditional cover piece 95 is mainly used to limit the ratchet 941 within the through hole 93 and prevent the ratchet 941 from separating. However, the connector 942 may has too large bias swing angle in a width direction of the head portion 92, and it causes that the detent member 96 may be pushed to move back by the block teeth 961 and the ratchet 941, as shown in FIG. 10, so the block teeth 961 cannot be fully engaged with the ratchet 941. At this time, if a user insists on driving the wrench, the block teeth 961 of the detent member 96 and the teeth of the ratchet 941 are worn easily, and the wrench may be damaged to be unusable in serious case.

### SUMMARY OF THE INVENTION

In order to solve the aforesaid problems, an objective of the present disclosure is to provide an improved structure of a wrench having a swingable ratchet. The via hole of the cover is used to restrict the bias swing angle of the driving member in the width direction of the head portion, to avoid problem of the wear between the block teeth of the detent member and the ratchet caused by non-full engagement. Therefore, such problem can be solved without extra adding other block element except the block ring.

Other objective of the present disclosure is to achieve the function of the block ring and the head portion being fixed and hard to be relatively rotated according to the simple structure.

To achieve the above-mentioned objective, a wrench includes a main body, a driving member, a detent member and a block ring.

The main body includes a handle and a head portion located at an end of the handle. The head portion is provided with a through hole therethrough, and a control room located at a side of the handle and laterally communicated with the through hole. The head portion is provided with a first opening and a second opening respectively located at two sides which the through hole is penetrated therethrough, and an inclined plane at an inner diameter of a peripheral side of the first opening gradually expanded from the first opening toward the through hole. The head portion is provided with a notch located at a peripheral side of the second opening. The notch has an inner diameter widened laterally. The head portion is provided with a ring groove formed by a step-like structure between the through hole and the notch, and an inner diameter of the ring groove being in a range between that of the through hole and the notch.

The driving member includes a spherical-shaped ratchet contained within the through hole, and a connector protruded from a side of the ratchet. The ratchet is abutted against the inclined plane by a side where the connector is disposed, to be pivotally swung correspondingly, and the connector is protruded out of the second opening.

The detent member is restricted within the control room and provided with block teeth at a side thereof faced toward the through hole. The block teeth can be engaged with the ratchet along the spherical shape of the ratchet to control a rotation direction of the driving member.

The block ring is provided with a ring rim located at the second opening of the head portion and placed in the ring groove, and a ring fastener embedded in the notch is used to block the ring rim in a direction of the block ring being departed from the head portion. The block ring us provided with a convex cover to restrict the ratchet within the through hole, the convex cover is provided with a via hole from which the connector is protruded, and the connector is abutted against an inner rim of the via hole at a periphery thereof, so as to restrict a bias swing angle of the driving member in the head portion in the width direction, and prevent the block teeth of the detent member from being departed from the ratchet, and enable the block teeth of the detent member to be fully engaged with the ratchet.

Preferably, the via hole is a rectangular hole, a length direction of the through hole is equal to the length direction of the handle and the width direction of the through hole is equal to a width direction of the head portion.

Preferably, the head portion is provided with a cavity inwardly recessed at a side surface of the second opening of the head portion at a side of the handle, and the cavity is laterally communicated with the through hole. The block ring has a block lug restricted within the cavity, and the block lug is used to stop the block ring from being rotated in a case of the length direction of the via hole equal to that of the handle.

Preferably, the block lug is located at a side of the block ring toward the cavity and laterally inserted into the cavity, and the depth of a cavity bottom of the cavity is substantially equal to the height of the ring rim and the block lug is abutted against a peripheral wall of the cavity and restricted within the cavity.

Preferably, the cover is in a convex-arc shape, and the convex arc is along with a curvature of the spherical shape of the ratchet.

### BRIEF DESCRIPTION OF THE DRAWINGS

The detailed structure, operating principle and effects of the present disclosure will now be described in more details hereinafter with reference to the accompanying drawings that show various embodiments of the present disclosure as follows.

FIG. 1 is a perspective appearance view of a wrench of a first embodiment of the present disclosure.

FIG. 2 is an exploded view of members of the head portion of the wrench of the first embodiment of the present disclosure.

FIG. 3 is a cross-sectional view of the head portion of the wrench of the first embodiment of the present disclosure.

FIG. 4 is a schematic view of the connector pivotally swung in a via hole along a length direction of the wrench of the first embodiment of the present disclosure.

FIG. 5 is a top plan view of the head portion of the wrench of the first embodiment of the present disclosure, and the connector is moved downwardly to be abutted against an inner rim of the via hole by a periphery thereof.

FIG. 6 is a top plan view of the head portion of the wrench of the first embodiment of the present disclosure, and the connector is moved upwardly to be abutted against an inner rim of the via hole by a periphery thereof.

FIG. 7 is a perspective appearance view of a wrench of a second embodiment of the present disclosure.

FIG. 8 is a top plan view of the head portion of the wrench of the second embodiment of the present disclosure, and the connector is pivotally swung along the length direction.

FIG. 9 is a partial cross-sectional view of a head portion of a traditional wrench.

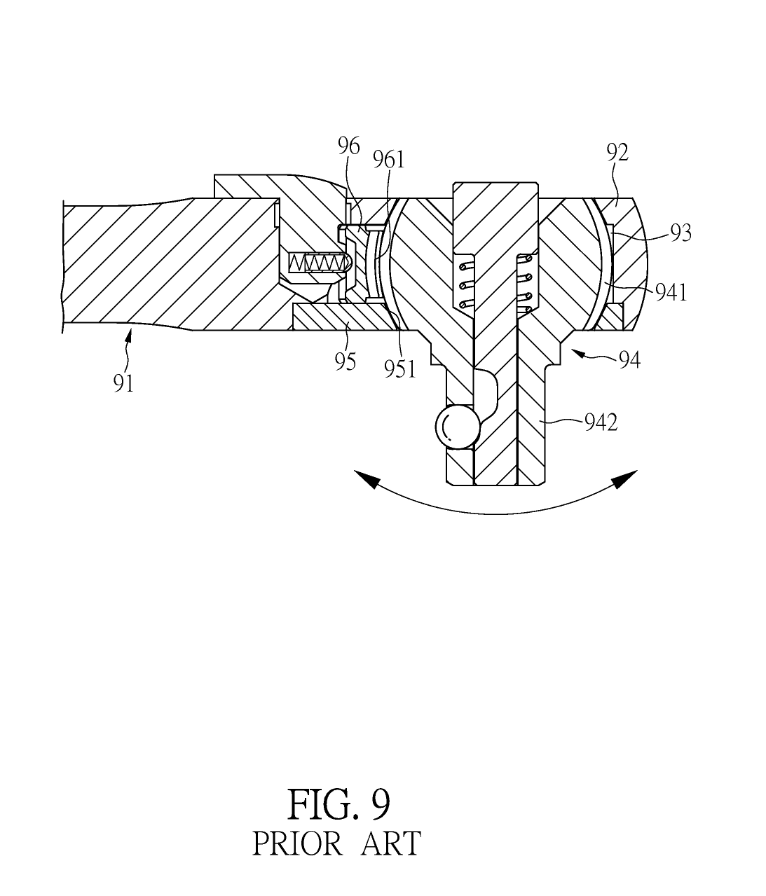

FIG. 10 is a schematic view of a traditional wrench being swung in a ratchet along a width direction of a head portion, and block teeth of a detent member is pushed by the ratchet to be move back to result in the non-full engagement between the block teeth and the ratchet.

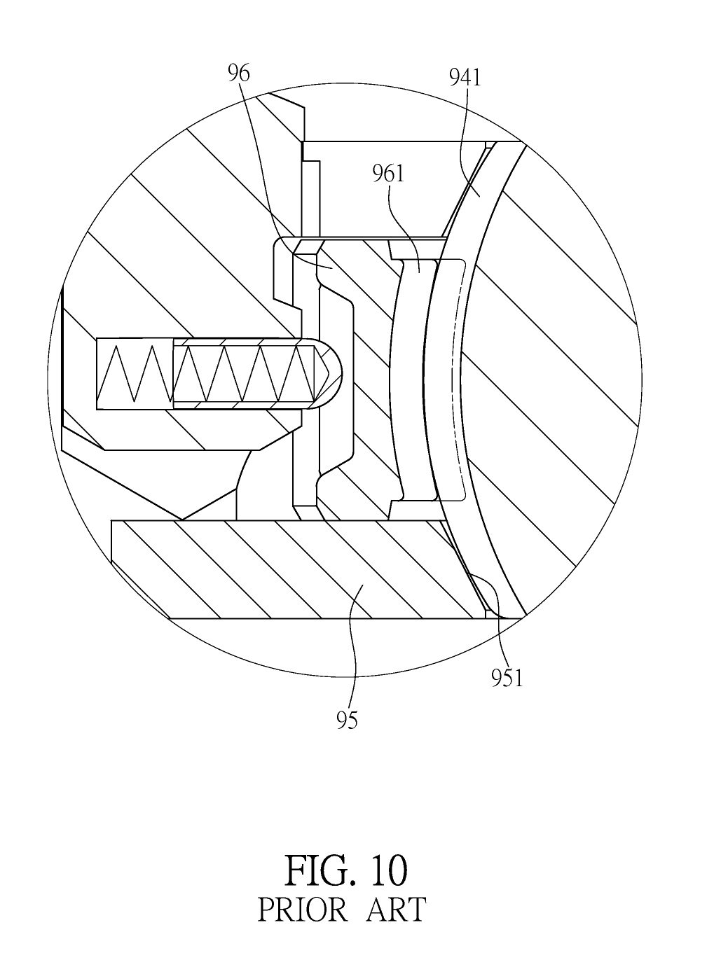

### DETAILED DESCRIPTION OF THE PREFERRED EMBODIMENTS

Reference will now be made in detail to the exemplary embodiments of the present disclosure, examples of which are illustrated in the accompanying drawings. Therefore, it is to be understood that the foregoing is illustrative of exemplary embodiments and is not to be construed as limited to the specific embodiments disclosed, and that modifications to the disclosed exemplary embodiments, as well as other exemplary embodiments, are intended to be included within the scope of the appended claims. These embodiments are provided so that this disclosure will be thorough and complete, and will fully convey the inventive concept to those skilled in the art. The relative proportions and ratios of elements in the drawings may be exaggerated or diminished in size for the sake of clarity and convenience in the drawings, and such arbitrary proportions are only illustrative and not limiting in any way. The same reference numbers are used in the drawings and the description to refer to the same or like parts.

It will be understood that, although the terms ‘first’, ‘second’, ‘third’, etc., may be used herein to describe various elements, these elements should not be limited by these terms. The terms are used only for the purpose of distinguishing one component from another component. Thus, a first element discussed below could be termed a second element without departing from the teachings of embodiments. As used herein, the term “or” includes any and all combinations of one or more of the associated listed items.

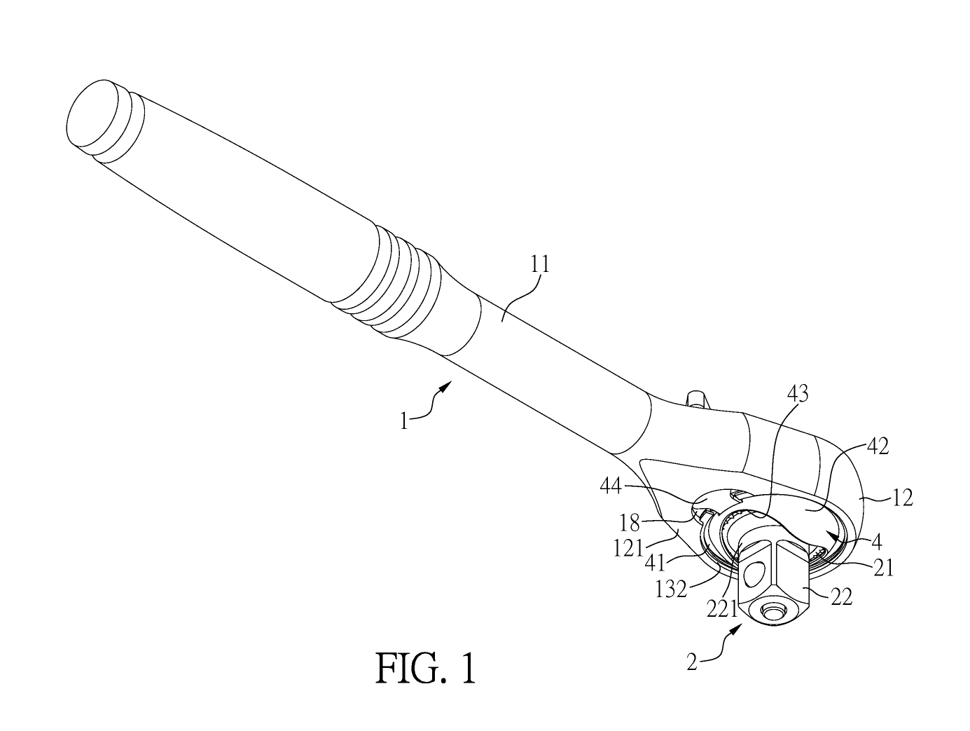

Please refer to FIG. 1 through FIG. 8 which show the structure of the embodiment of the present disclosure, respectively. The structures shown in FIG. 1 through FIG. 8 are taken as examples for illustration; however, the present disclosure is not limited thereto.

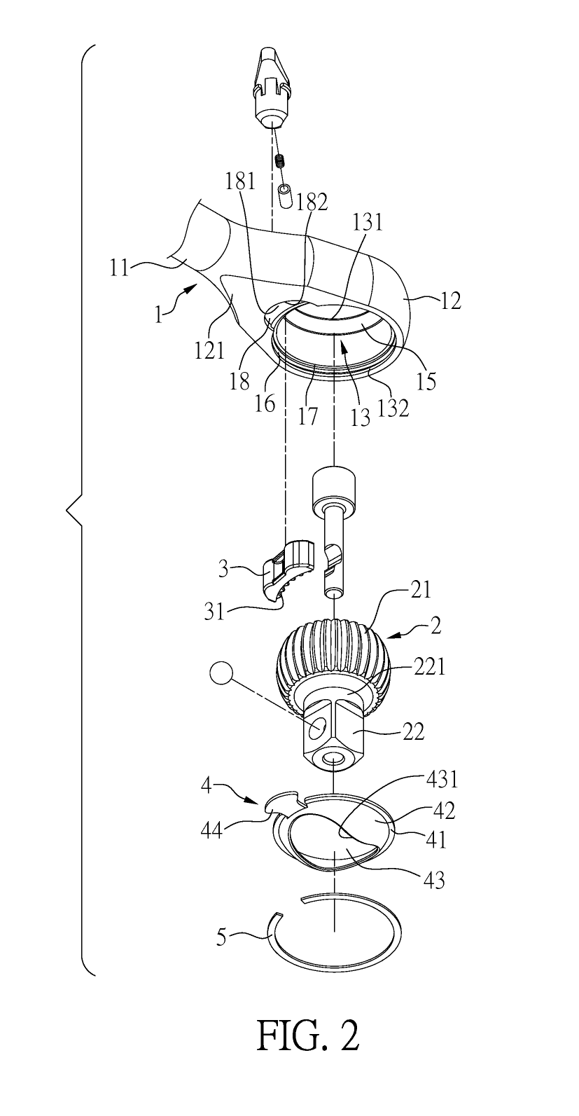

This embodiment provides an improved structure of wrench having a swingable ratchet. As shown in FIG. 1 and FIG. 2, the wrench includes a main body 1, a driving member 2, a detent member 3, a block ring 4 and a ring fastener 5.

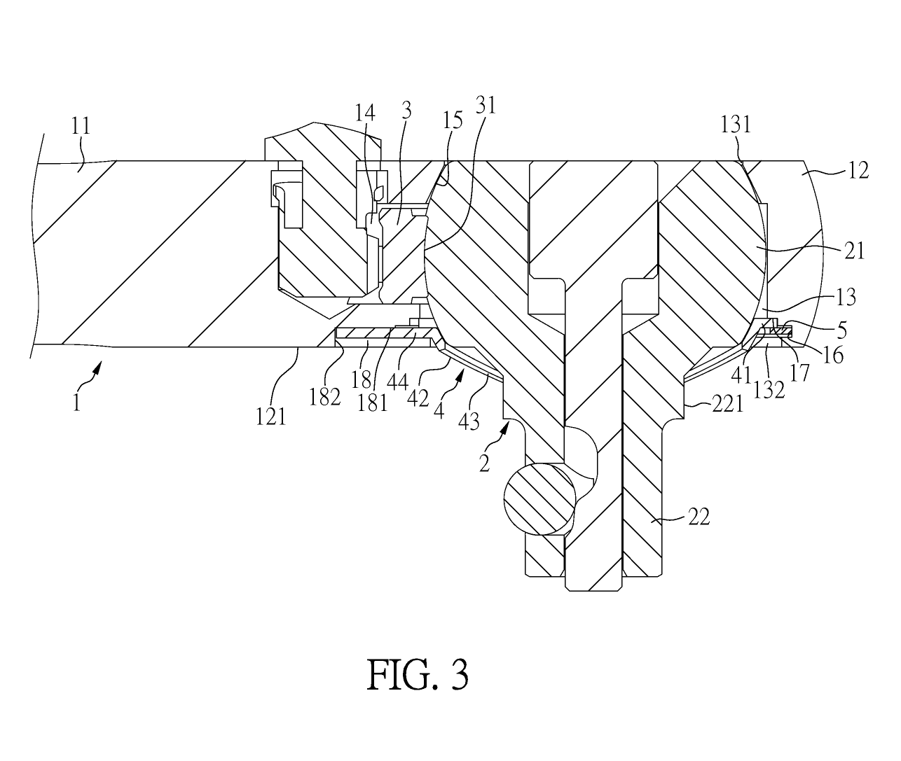

As shown in FIG. 2 and FIG. 3, the main body 1 includes a handle 11, and a head portion 12 located at an end of the handle 11. The head portion 12 is provided with a through hole 13 therethrough, and a control room 14 located at a side of the handle 11 and lateral communicated with the through hole 13. The head portion 12 is provided with a first opening 131 and a second opening 132 at two sides of the through hole 13, respectively. The head portion 12 has an inclined plane 15 at a peripheral side of the first opening 131, and an inner diameter of the inclined plane 15 is gradually expanded from the first opening 131 toward the through hole 13. The head portion 12 is provided with a notch 16 at a peripheral side of the second opening 132, and the notch 16 has an inner diameter which is widened laterally. In the head portion 12, a step-like structure is disposed between the through hole 13 and the notch 16 to form a ring groove 17, and an inner diameter of the ring groove 17 is in a range between that of the through hole 13 and the notch 16.

As shown in the FIG. 2 and FIG. 3, the driving member 2 includes a spherical-shaped ratchet 21 contained within the through hole 13, and a connector 22 protruded from a side of the ratchet 21. The ratchet 21 is abutted against the inclined plane 15 by a side where the connector 22 is disposed, and pivotally swung correspondingly. The connector 22 is protruded out of the second opening 132.

As shown in FIG. 2 and FIG. 3, the detent member 3 is restricted to stay in the control room 14. The detent member 3 is provided with block teeth 31 at a side thereof faced toward the through hole 13, and the block teeth 31 may be engaged with the ratchet 21 along the spherical shape of the ratchet 21 to control a rotation direction of the driving member 2.

As shown in FIG. 2 and FIG. 3, the block ring 4 is provided with a ring rim 41 located at the second opening 132 of the head portion 12 and placed in the ring groove 17. The ring fastener 5 is embedded in the notch 16 and used to block the ring rim 41 in a direction of the block ring 4 being departed from the head portion 12. The block ring 4 is provided with a cover 42 which is in a convex-arc shape in this embodiment, and the convex arc is along with a curvature of the spherical shape of the ratchet 21. The cover 42 is used to restrict the ratchet 21 to stay within the through hole 13. The cover 42 is provided with a via hole 43 from which the connector 22 is protruded.

As shown in FIG. 1 through FIG. 3, the via hole 43 is a rectangular hole in this embodiment, its length direction is equal to the length direction of the handle 11 and its width direction is equal to the width direction of the head portion 12. The head portion 12 is provided with a cavity 18 at a side of the handle 11. The cavity 18 is recessed at a side surface 121 of the second opening 132 of the head portion 12, and laterally communicated with the through hole 13. The block ring 4 has a block lug 44 restricted within the cavity 18, and the block lug 44 is used to stop the block ring 4 from being rotated in a case of the length direction of the via hole 43 equal to that of the handle 11.

The block lug 44 of this embodiment is located a side of the block ring 4 toward the cavity 18 and laterally inserted into the cavity 18. The depth of cavity bottom 181 of the cavity 18 is substantially equal to the height of the ring rim 41, and the block lug 44 is abutted against a peripheral wall 182 of the cavity 18 and restricted within the cavity 18.

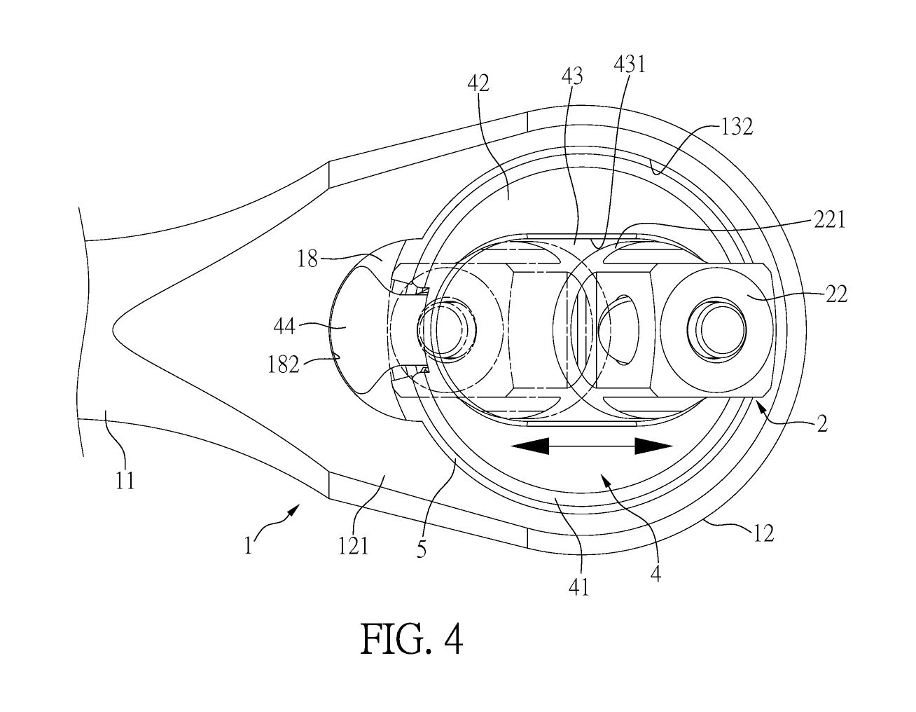

As shown in FIG. 4, the via hole 43 is a rectangular hole and the connector 22 is swung in a length directional stroke of the via hole 43, at this case, the ratchet 21 is rotated correspondingly to a swingable range of the connector 22, and the swing angle of the connector 22 swung from an end of the via hole 43 at length direction to other end remote is approximately 50 degrees. The user may mount a sleeve onto the connector 22 to drive an element (such as bolt or screw) in the range of the swing angle.

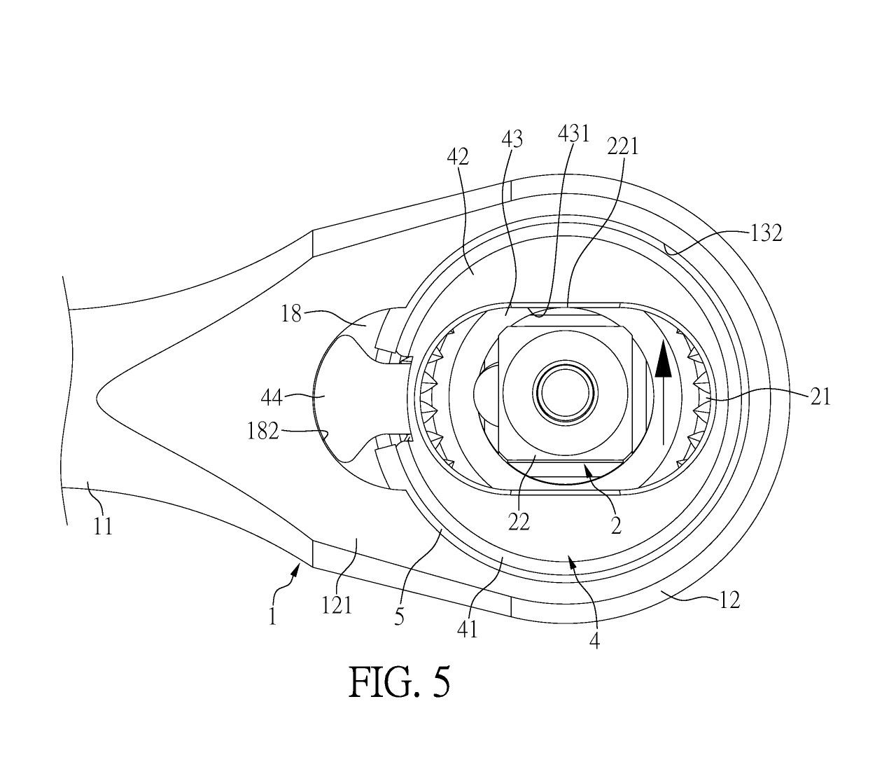

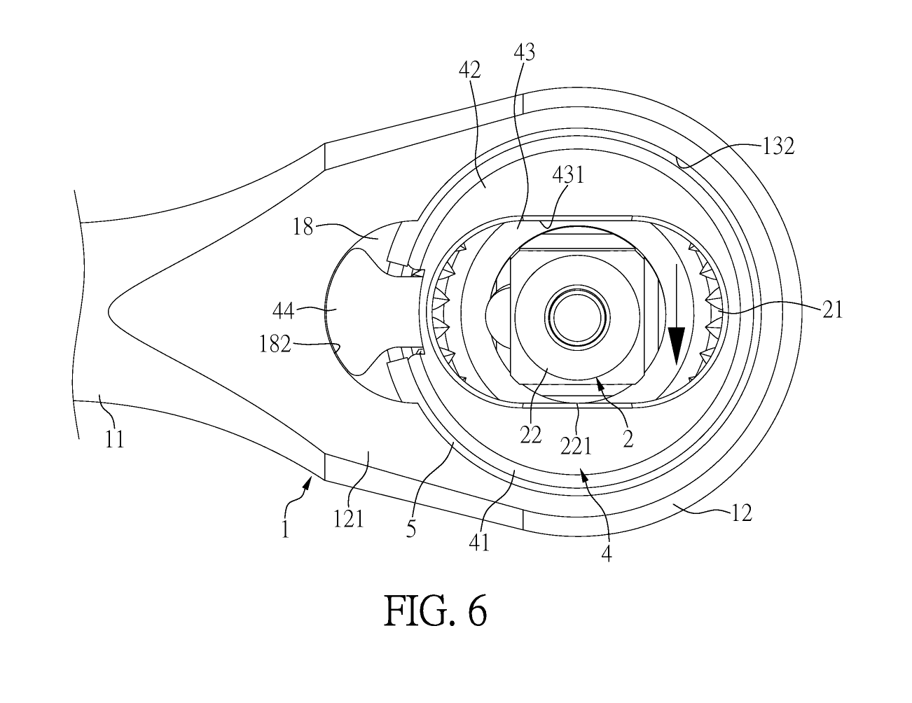

As shown in FIG. 5 and FIG. 6, the connector 22 of the driving member 2 may be forced to move toward the width direction of the head portion 12, such as the connector 22 of the FIG. 5 being forced to move toward an upper part in the drawing, or the connector 22 being forced to move toward a lower part in the drawing. Although a small gap exists between the inner rim 431 of the via hole 43 and the periphery 221 of the connector 22, when the connector 22 is swung to the periphery 221 thereof to abut against the inner rim 431, the connector 22 is swung with a slight amplitude on the width direction (approximately 1 degree of swing angle), and the bias swing angle of the driving member 2 in the width direction of the head portion 12 is restricted, so the problem of the detent member 3 being pushed by the block teeth 31 and the ratchet 21 to move back can be avoid, and the block teeth 31 of the detent member 3 can be fully engaged with the ratchet 21.

According to the aforesaid illustration, the advantages of the present disclosure are obvious.

First, the cover 42 of the block ring 4 can be used to restrict the ratchet 21 of the driving member 2 to stay in the through hole 13 of the head portion 12 of the main body 1, the cover 42 is provided with the via hole 43 from which the connector 22 of the driving member 2 can be protruded, and the periphery 221 of the connector 22 is abutted against the inner rim 431 of the via hole 43, so the bias swing angle of the driving member 2 in the width direction of the head portion 12 can be restricted. Therefore, the engagement between the block teeth 31 of the detent member 3 and the ratchet 2 will not be separated, to ensure the block teeth 31 of the detent member 3 to be fully engaged with the ratchet 2, so that the problem of the block teeth 31 of the detent member 3 and the ratchet 2 being worn due to non-full engagement therebetween can be prevented, and the wrench of the present disclosure can be maintained in a normal usage state.

Secondly, in order to ensure that the connector 22 of the driving member 2 is pivotally swung in the via hole 43 along the length direction of the handle 11 of the main body 1, the via hole 43 of the block ring 4 is the rectangular hole whose length direction equal to that of the handle 11, the head portion 12 of the main body 1 is provided with the cavity 18 and the block ring 4 is provided with the block lug 44 restricted in the cavity 18, so that the block ring 4 cannot be rotated in the case of the length direction of the via hole 43 of the block ring 4 equal to that of the handle 11 of the main body 1. Therefore, the function of making the block ring 4 and the head portion 12 be fixed and not rotated relatively can be achieved based on this simple structure.

Thirdly, compared with the traditional cover piece 95 which is just used to restrict the ratchet 941 within the through hole 93 but cannot prevent the connector 942 from being bias swung in the width direction of the head portion 12, the block ring 4 of the present disclosure can be used to restrict the ratchet 21 to stay within the through hole 13 of the head portion 12 by the ring rim 41 thereof and, meanwhile, the cover 42 having the via hole 43 can limit the bias swing angle of the driving member 2 in the width direction of the head portion 12 without extra disposing other stop element. Therefore, the problem of the traditional cover piece 95 can be solved.

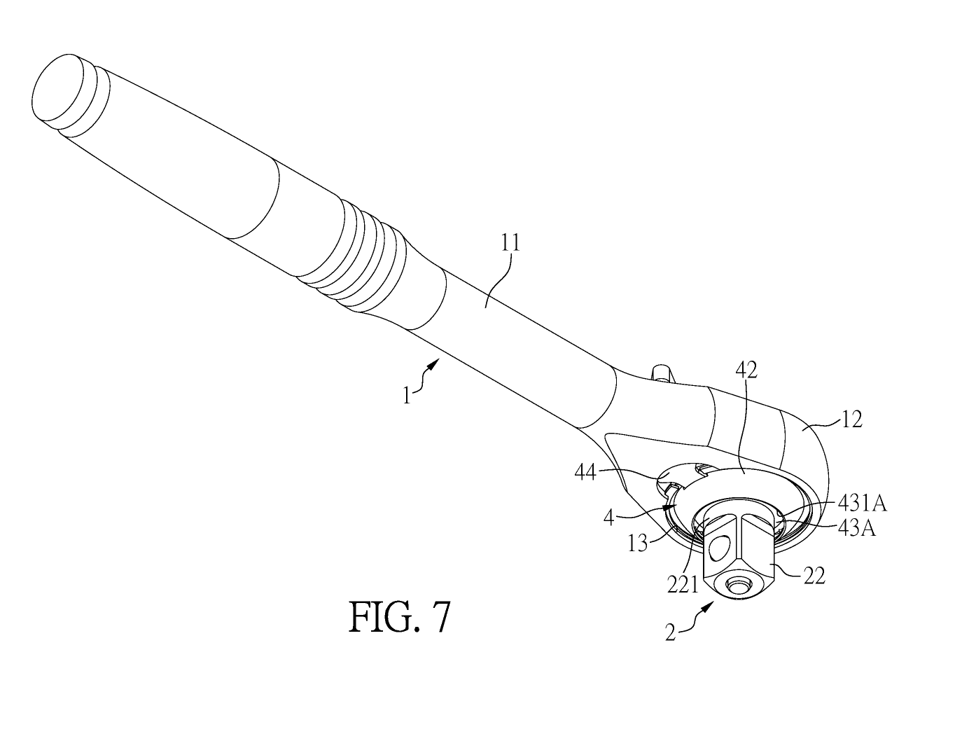

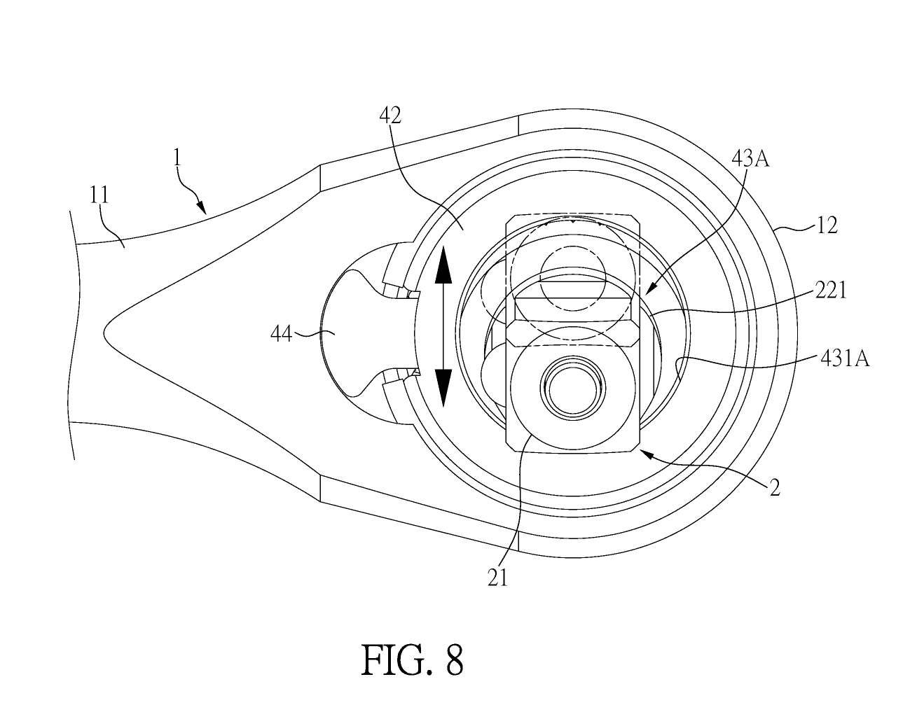

Naturally, there are many examples embraced by the scope of the present disclosure, and these examples just have different variations in detail. Please refer to FIG. 7 which shows a second embodiment of the present disclosure. The main difference between the second embodiment and the first embodiment is that the via hole 43A is a round hole, its aperture is the same in the length direction of the handle 11 and the width direction of the head portion 12 both, and a bias swing angle of the driving member 2 in the head portion 12 in the width direction is limited to 30 degrees by an inner rim 431A of the via hole 43A. That is, when the driving member 2 is located at the middle position, as shown in FIG. 8, the two side of the head portion 12 can be bias swung by 15 degrees at the two sides in the width direction and, at this time, the block teeth 31 of the detent member 3 is still efficiently engaged with the ratchet 21 and not departed from the ratchet 21, so as to achieve the function the same as that of the first embodiment.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

1. A wrench having swingable ratchet, comprising:
a main body, comprising a handle and a head portion located at an end of the handle, the head portion provided with a through hole therethrough and a control room located at a side of the handle and laterally communicated with the through hole, the head portion provided with a first opening and a second opening respectively located at two sides of the through hole, and an inclined plane at an inner diameter of a peripheral side of the first opening gradually expanded from the first opening toward the through hole, the head portion provided with a notch located at a peripheral side of the second opening, the notch having an inner diameter widened laterally, the head portion provided with a ring groove formed by a step-like structure between the through hole and the notch, and an inner diameter of the ring groove being in a range between that of the through hole and the notch;
a driving member, comprising a spherical-shaped ratchet contained within the through hole, and a connector protruded from a side of the ratchet, wherein the ratchet is abutted against the inclined plane by a side where the connector is disposed, to be pivotally swung correspondingly, and the connector is protruded out of the second opening;
a detent member, restricted within the control room and provided with block teeth at a side thereof faced toward the through hole, wherein the block teeth can be engaged with the ratchet along the spherical shape of the ratchet to control a rotation direction of the driving member;
a block ring, provided with a ring rim located at the second opening of the head portion and placed in the ring groove, and a ring fastener embedded in the notch used to block the ring rim in a direction of the block ring being departed from the head portion, The block ring provided with a convex cover to restrict the ratchet within the through hole, the convex cover provided with a via hole from which the connector is protruded, and the connector abutted against an inner rim of the via hole at a periphery thereof, so as to restrict a bias swing angle of the driving member in the head portion in the width direction, and prevent the block teeth of the detent member from being departed from the ratchet, and enable the block teeth of the detent member to be fully engaged with the ratchet.

2. The wrench as defined in claim 1, wherein the via hole is a rectangular hole, the length direction of the via hole is equal to the length direction of the handle and the width direction of the through hole is equal to a width direction of the head portion.

3. The wrench as defined in claim 2, wherein the head portion is provided with a cavity inwardly recessed at a side surface of the second opening of the head portion at a side of the handle, the cavity is laterally communicated with the through hole, the block ring has a block lug restricted to stay in the cavity, and the block lug 44 is used to stop the block ring from being rotated in a case of the length direction of the via hole equal to that of the handle.

4. The wrench as defined in claim 3, wherein the block lug is located at a side of the block ring toward the cavity and laterally inserted into the cavity, and the depth of a cavity bottom of the cavity is substantially equal to the height of the ring rim and the block lug is abutted against a peripheral wall of the cavity and restricted in the cavity.

5. The wrench as defined in claim 1, wherein the cover is in a convex-arc shape and the convex arc is along with a curvature of the spherical shape of the ratchet.

6. The wrench as defined in claim 1, wherein the via hole is a round hole and has an aperture the same in the length direction of the handle and the width direction of the head portion both, and a bias swing angle of the driving member of the head portion in the width direction is limited to 30 degrees by an inner rim of the through hole.
